(19) United States
(12) Patent Application Publication
(10) Pub. No.: US 2020/0282708 A1
(43) Pub. Date: Sep. 10, 2020

(54) COMPOSTABLE FOOD PACKAGING MATERIAL AND METHOD FOR PRODUCING

(71) Applicant: Identi-grphics, Inc., Montgomery, IL (US)

(72) Inventor: Aaron Leuer, Montgomery, IL (US)

(21) Appl. No.: 16/292,281

(22) Filed: Mar. 4, 2019

(51) Int. Cl. B32B 19/04; B32B 7/12

(52) U.S. Cl. CPC B32B 19/04; B32B 2307/7163; B32B 2439/70; B32B 7/12

(57) ABSTRACT

A food packaging material, a method of making such a material, and a substantially completely compostable package made from such material, are disclosed. The packaging includes constructions wherein a single ply or double ply of substantially completely compostable substrate layers sealingly-engaged to one another using a natural food-grade contact adhesive, advantageously results in a substantially completely compostable natural food packaging material. The method utilizes existing commercial machinery and processes to form compostable substrates into packaging, including application of print indicia.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX”

(Not Applicable)

### BACKGROUND OF THE INVENTION

### 1. Field of the Invention

This invention relates to food packaging materials, specifically a compostable food packaging material for energy and protein bars.

### 2. Description of the Related Art

Cold-sealed food packaging materials are typically formed by sealing two layers of material together using pressure rather than elevated temperatures. Cold-sealable substrate materials are known for use in packaging products that would be adversely affected by exposure to heat, such as might occur during heat-sealing of substrate materials, after the food product has been produced.

In cold-sealing, two substrate layers are utilized. First, a clear film layer with reverse ink printing is introduced to a second layer, typically a metalized foil layer. These two layers are sealed together by a cohesive glue that fuses the two layers using pressure at the areas where glue is applied. Cold seal cohesive glues are used in a wide range of applications, including food wrappers, particularly packaging for protein bars and candy bars. For those applications in which food contact is possible, users must be certain the adhesive meets all FDA regulations.

When the first substrate coated with a cold seal cohesive comes into contact with itself or seal areas coated with the same cold seal cohesive, the bond results by using simple digital pressure. This differs from a heat seal adhesive that requires adhesive only on one substrate but must have a source of heat and pressure to make the bond.

Prior art in this field utilizes substrate materials that are not compostable. The market demand from consumers, food producers, and regulators is pushing packaging manufacturers to create substantially completely compostable food packaging materials. That is, there is a need in the industry for a ‘biodegradable’ packaging for food.

### SUMMARY OF THE INVENTION

The present invention relates to packaging material for a food product that avoids, or at least reduces, some of the problems of the prior art materials. The invention provides food packaging material that is organically compostable and a method for manufacturing the material.

### BRIEF DESCRIPTION OF THE SEVERAL VIEWS OF THE DRAWINGS

FIG. 1 is view in perspective of a sectional view of the packing according to the present invention, with the single ply layer of compostable material displayed.

FIG. 2 is view in perspective of a sectional view of the packing according to the present invention, with the double ply layer of compostable material displayed.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

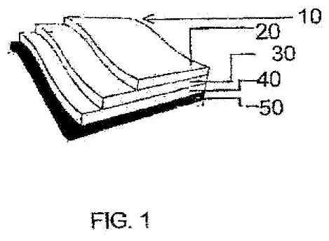

Looking at FIG. 1, one form of the present invention is shown in cross-sectional view. FIG. 1 displays a flexible sheet material 10 for packaging food contents which is preferably a ‘protein’, ‘nutrition’ or ‘power’ bar. The flexible sheet material 10 has multiple layers comprised of a release coating layer 20 at the outermost layer, then an ink layer 30, a layer of naturally organic material of packaging material 40, and a cold seal layer 50.

The cold seal layer 50 is the innermost layer enclosing the food contents. A storage space containing the contents is defined by the area within the sheet 10. The storage space is sealed off from the surrounding environment and protects the food from the environment.

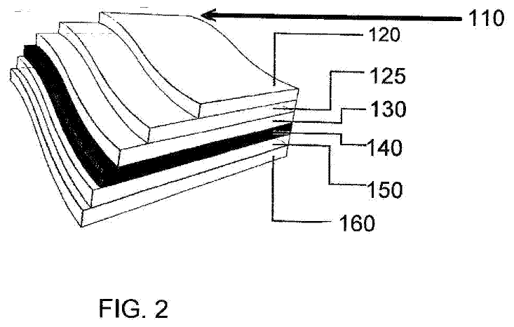

Looking at FIG. 2, another form of the present invention is shown in cross-sectional view. FIG. 2 displays a flexible sheet material 110 for packaging food contents which also is a ‘protein’, ‘nutrition’ or ‘power’ bar. The flexible sheet material 110 has multiple layers comprised of a release coating layer 120 at the outermost layer, then a layer of first naturally organic material 125, an ink layer 130, a laminating adhesive layer 140, a second layer of naturally organic material 150, and a cold seal layer 160.

The cold seal layer 160 is the innermost layer enclosing the food contents. A storage space containing the food is defined by the area within the sheet 110. The storage space is sealed off from the surrounding environment and protects the food from the environment.

Machines for forming and sealing such materials 10 and 110 can be manufactured from machines that are available commercially. The present inventive process can be utilized may be based on a single ply or a doubly ply of the compostable materials 50 and 150. Graphic indicia, in the form of non-toxic inks 30 and 130 are typically reverse applied to the outer surface of the laminating adhesive layers 40 and 140, for indicating nutrition information, trademarks, and coloring.

The inks 40 and 140 are applied in discrete areas, thereby displaying color as a background but may instead be applied in a continuous layer. The inks 40 and 140 must be a conventional ink suitable for printing on food packaging and may be applied by printing processes known for the purpose.

In the preferred embodiment for the present invention, the food packaging product materials 10 and 110 are substantially completely compostable. For example, the materials 10 and 110 may be, in any combination, up to 100% biodegradable paper-based or vegetable fiber-based material, plant material, or similar natural material that readily degrades in the outdoor environment.

The cold seal coatings 50 and 160 may be continuous layers but preferably are pattern-applied at only those places where a seal is to be formed. That entails maintaining register between the back side with the coatings 50 and 160 and the front side with the printing. Preferably, the cold seal coating machine is a flexographic or rotogravure printing machine forming part of the same production line as, and is mechanically synchronized with, the printing press for disposing the inks 30 and 130.

Flexographic and rotogravure printing machines are well known in the art and, in the interests of conciseness, will not be described here. The package forming and cutting machine can then be kept in register with the cold seal pattern in the same way as it is kept in register with the ink printing on the reverse side of the materials 10 and 110. Methods of, and apparatus for, keeping subsequent machines in register with a printed pattern are well-known in the art and in the interests of conciseness will not be described here.

The method of production of the material 10 comprises the steps of first positioning the first layer of naturally organic material 40 for disposing the other layers upon it. Then the ink layer 30 is applied onto the adhesive layer 40. After the ink 30 is applied, the release coating layer 20 is applied as the outermost layer. The cold seal layer 50 is pressed to the material 40 with layers 20, 30, and 40 and spooled for transfer to the food manufacturing site, which will then further process the spooled packaging by adding the food. The release coating 20 is necessary to allow the packaging material 10 to become unspooled.

The method of production of the material 110 comprises providing the second naturally organic material 125. The release coating is applied to the outer layer of the material 125. The ink layer 130 is applied and the onto the underside of the material 125, and then an adhesive layer 140 is applied to the ink layer 130. The second naturally organic material 150 is then applied. After the second organic material layer 150 is applied, the cold seal layer 160 is pressed to the material 125 with layers 120, 130, and 140 and spooled for transfer to the food manufacturing site, which will then further process the spooled packaging further.

In conclusion, the present invention in using the aforementioned structure has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein. It is of course to be understood that the embodiments described herein are merely illustrative of the principles of the invention and that a wide variety of modifications thereto may be affected by persons skilled in the art without departing from the spirit and scope of the invention as set forth in the following claims.

What is claimed is:

1. A substantially completely compostable packaging material for a food comprising:
a flexible sheet layer having an outer surface and an inner surface;
a layer of cold-seal release coating disposed on an area of the outer surface of said sheet layer;
an ink disposed on an area of the outer surface of said sheet layer for color, print and imaging;
a cold seal cohesive disposed on areas of the inner surface of said sheet layer and in contact with said food,
wherein the sheet layer is a naturally organic compostable material that is substantially completely biodegradable.

2. A substantially completely compostable packaging material for a food comprising:
an outer first flexible sheet layer;
a layer of cold-seal release coating disposed on outer first flexible sheet layer;
an inner second flexible sheet layer disposed inwardly toward said food, relative to said outer first flexible sheet layer;
an ink disposed for color, print and imaging on said second flexible sheet layer;
a cold seal cohesive disposed on areas of the inner surface of said inner second sheet layer and in contact with said food,
wherein each of the sheet layers is a naturally organic compostable material that is substantially completely biodegradable.

3. A method of making a substantially completely compostable packaging material for a food comprising the steps of:
providing a first flexible sheet layer;
disposing a cold-seal release coating onto an area of the outer surface of said first sheet layer;
providing a second flexible sheet layer inwardly toward said food relative to said first sheet layer;
applying a glue or laminating adhesive on the outer surface of said second or inner surface of said first flexible sheet layer;
printing color and graphic indicia onto an area of the inner surface of said first sheet layer;
disposing a cold seal cohesive layer onto areas of the inner surface of said second sheet;
wherein the first flexible sheet layer and the second flexible sheet layer is a naturally organic compostable material that is substantially completely biodegradable.

4. A method of making a substantially completely compostable packaging material for a food comprising the steps of:
providing a first flexible sheet layer;
disposing a cold-seal release coating onto an area of the outer surface of said first flexible sheet layer;
printing color and graphic indicia onto an area of the outer surface of said first flexible sheet layer;
disposing a cold seal cohesive layer onto areas of the inner surface of said first flexible sheet layer;
wherein the first flexible sheet layer is a naturally organic compostable material that is substantially completely biodegradable.
